(19) United States
(12) Patent Application Publication
(10) Pub. No.: US 2022/0325949 A1
(43) Pub. Date: Oct. 13, 2022

(54) PORTABLE FOOD STORAGE AND PREPARATION DEVICE

(71) Applicant: SHIEKH MOHAMAD THAMER M J AL-THANI, DOHA (QA)

(72) Inventor: SHIEKH MOHAMAD THAMER M J AL-THANI, DOHA (QA)

(21) Appl. No.: 17/225,697

(22) Filed: Apr. 8, 2021

(51) Int. Cl. F25D 31/00; F25D 11/00; A47J 31/00; F25D 16/00

(52) U.S. Cl. CPC F25D 31/005; F25D 11/00; A47J 31/005; F25D 16/00; A47J 41/0038

(57) ABSTRACT

The portable food storage and preparation device provides food storage and preparation facilities in a wheeled enclosure. The device has a portable power supply, a controller, a refrigerating module, a food heating module, and a beverage module. The refrigerating module is able to maintain food chilled either with chill packs or a refrigeration unit. The beverage module has a first water storage tank and a water heater, and water from the beverage module can be supplied to food being heated or cooked in the food heating module.

### BACKGROUND

### 1. Field

The present disclosure relates generally to portable food handling devices, and particularly to a portable food storage and preparation device.

### 2. Description of the Related Art

Portable food preparation devices take multiple forms. Generally, an elaborate food cart permits maintaining a desired food temperature, occasionally with a heating appliance. There are also portable refrigerators, although most portable refrigeration requires an external power connection, typically a 12-volt vehicle power supply. Similar power supplies are provided on portable carts intended to store and supply electronic devices, such as electronic device carts sold by Tripp Lite, an example being the Tripp Lite CSC32AC cart with 32 AC outlets. The Tripp Lite cart is intended for storage and transportation of multiple devices, in which the devices are re-charged during storage.

More closely related to portable food service are kitchen appliances intended for installation in recreational vehicles and sleeper compartments in trucks. These are obviously portable, at least in the sense that their installation is in a vehicle, but do not afford portability independent of the vehicle in which they are installed. Moreover, such equipment is generally dependent on external power or the electric power supply provided by the associated vehicle. More often, portable equipment comprises individual coolers and portable cooking equipment used for camping.

Portable food preparation systems can be used for a variety of purposes in which it is desired to have food preparation localized. This is useful for people that follow specific diets, and for other instances in which local food preparation is desired. Thus, a portable food storage and preparation device solving the aforementioned problems is desired.

### SUMMARY

The portable food storage and preparation device is configured as a wheeled enclosure and includes a power supply, a controller, a refrigeration unit, a food heating chamber, and a beverage module. The refrigeration module has a cold storage area and a cooling source. The cooling source may be provided as chill packs, and an electric refrigeration unit may also be provided. The controller activates the electric refrigeration unit according to availability of electric power. The food heating module includes a food heating chamber and a device for heating food within the food heating chamber. The beverage module has a first water storage tank and a water heater having a second water tank, the water heater receiving water from the first water tank and heating the water either on demand or maintaining heated water on a standby basis. The beverage module also includes a beverage dispensing station, providing cold water from the first water storage tank either directly or after passing through the refrigeration module. The beverage module separately provides hot water from the water heater. A hot beverage preparation device receives hot water from the water heater, allowing selective dispensing of hot water or preparation and dispensing of hot beverages. The beverage module further provides water used in preparation of food in the food heating module. The controller provides power from the power supply to the refrigeration module, food heating module, and beverage module; provides control of the refrigeration module, food heating module and beverage module; and monitors temperature and cold storage of food.

These and other features of the present subject matter will become readily apparent upon further review of the following specification.

### BRIEF DESCRIPTION OF THE DRAWINGS

FIG. 1A is a perspective view of an exemplary portable food storage and preparation device, showing the external housing.

FIG. 1B is a schematic diagram of the portable food storage and preparation device of FIG. 1, showing an exemplary arrangement of compartments inside the housing.

FIG. 2 is a schematic diagram of a portion of the portable food storage and preparation device of FIG. 1, showing components for the preparation of heated food and beverages.

FIG. 3 is another schematic diagram of the portable food storage and preparation device of FIG. 1, showing a system for controlling the various food preparation devices.

FIG. 4 is a further schematic diagram of the portable food storage and preparation device of FIG. 1, showing additional details of the control system of FIG. 3.

Similar reference characters denote corresponding features consistently throughout the attached drawings.

### DETAILED DESCRIPTION OF THE PREFERRED EMBODIMENTS

The portable food storage and preparation device provides for storage and preparation of food. The device is configured to be portable. The portability can be achieved by any convenient means. For example, the device may be a wheeled cart taking the general form factor of a wheeled suitcase, which can be conveniently transported to a desired location. However, other configurations can be used.

When configured as a wheeled cart, the device may be provided in the form of a suitcase-shaped body having two ground-engaging wheels and an extendable handle. The front of the body includes a hinged cover to protect the internal components. The interior of the body includes a refrigerator, a food heating device, a water tank and heater, a hot water dispenser, and, optionally, a coffee dispenser. The device can be battery-powered and includes the necessary pumps and control circuitry for operation. In addition, the device can be controlled remotely via a mobile wireless communication device application. The device incorporates one or more food-heating devices, which may comprise a thermal oven, a microwave oven, a steamer, or a combination cooking unit, such as a thermal and microwave oven.

Portable food preparation systems can be used for a variety of purposes in which it is desired to have food preparation localized. This is useful for people that follow specific diets, and for other instances in which local food preparation is desired. This is suitable for athletes who frequently travel to sports venues, people that follow diets, as well as people who observe dietary restrictions, and individuals who travel in the course of their profession, but prefer on-site food preparation. The suitcase holds all the food for that person for a limited time period, e.g., a day, including everything that is necessary to preserve and prepare the food. The device can be used for outdoor and indoor food preparation, for example, to augment food prepared at an outdoor location.

The device differs from in-room kitchens in that preliminary preparation and stocking of the device can be performed at an ordinary kitchen or food service facility, which allows for storage and, where permitted, preliminary preparation of the food itself. The device allows fresh preparation of food on-site for service at remote locations, and also provides a convenient food preparation area for travelers. The device also facilitates adhering to specific dietary restrictions while travelling or at remote locations.

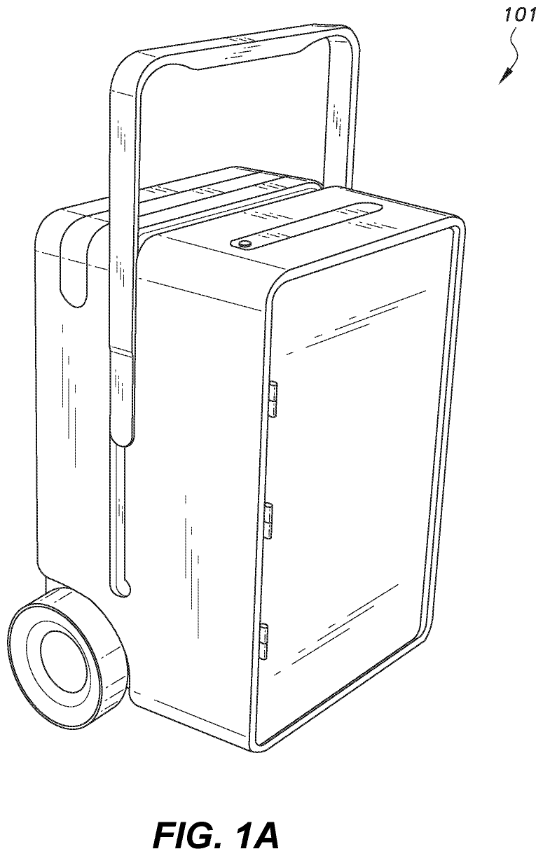

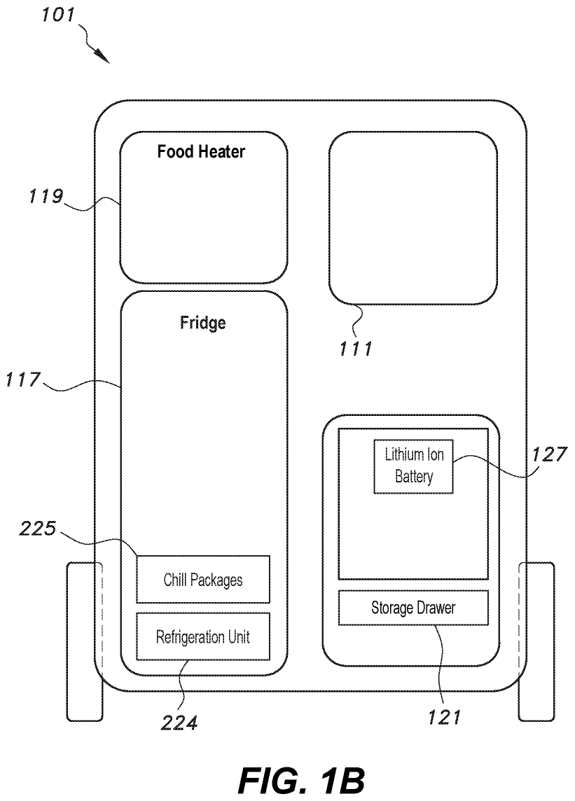

FIGS. 1A and 1B show an exemplary portable food storage and preparation device 101 configured as a wheeled cart following the general form of a wheeled suitcase, having wheels and an extendable handle mounted on the housing. The device takes the form of a wheeled cart and includes a water dispenser and coffee maker unit 111, refrigeration compartment 117 for storing and preserving food and/or beverages requiring refrigeration at temperatures below the ambient temperature, food heating unit 119, storage drawer 121, and a battery 127.

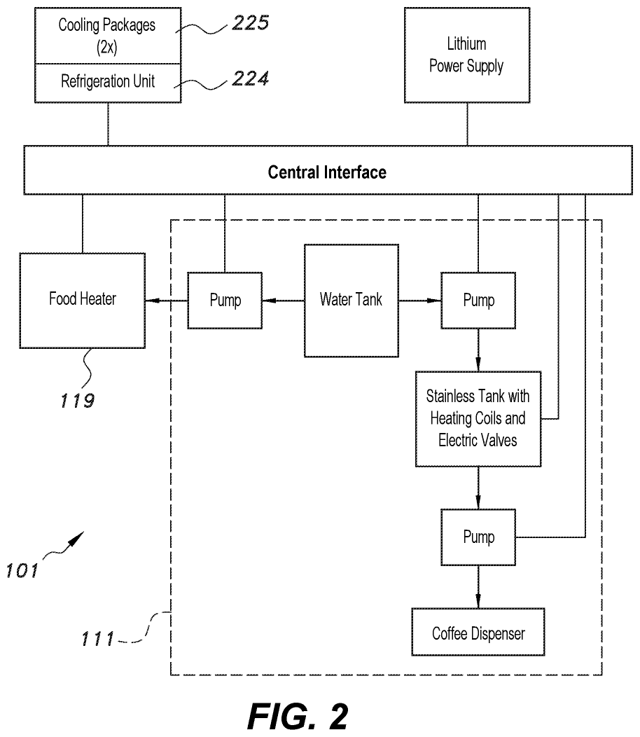

FIG. 2 is a schematic diagram showing components for the preparation of heated food and beverages that are installed in the housing of the device 101. Refrigeration unit 224 uses heat exchange, for example, as a Peltier chiller or as a fluid cycle refrigeration unit. While heat exchange refrigeration can be provided, it is alternatively possible to use chill packages (cold packs or “blue ice”) 225, dry ice (CO₂), or other externally chilled chilling elements to effect cooling in the refrigeration compartment 117. In many cases, it is expected that external power will be available at an on-site location, so both the refrigeration unit 224 and cold packs 225 can be provided. The combination allows heat exchange cooling to be used when electric power is available or when access to electric power within a short time period consistent with continued operation is expected.

In addition, the heat exchanger can be configured to dispense of waste heat by augmenting heat in the food heating unit.

The food heating unit 119 can be a microwave oven, steamer, or a conventional heating unit similar to a toaster oven. Multiple-function food heating units can be used, for example, providing conventional heating and/or microwave heating. It is also possible to use additional food heating devices, such as a table-top burner or range unit mounted to either the top of the device 101 or in a pull-out section. In addition to manual control, it is possible to provide for heating of the food automatically, either by on-device controls or through an app on an external wireless communication device.

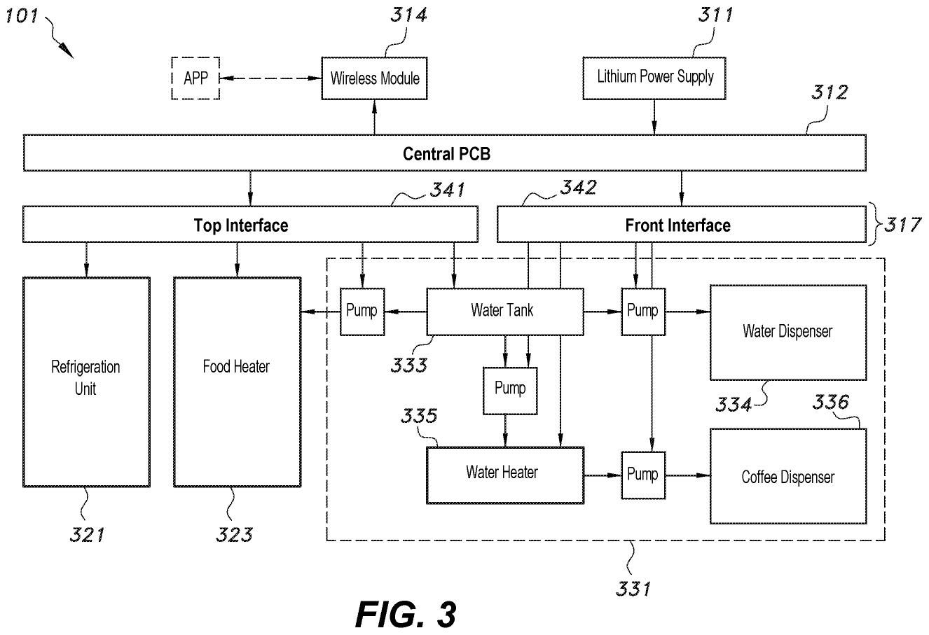

FIG. 3 is a schematic diagram showing a system for controlling the various food preparation devices. Depicted are a power supply module 311, central controller and power control module 312, wireless interface 314, food preparation control module 317, food refrigeration module 321, and food heating and cooking module 323. Also depicted is beverage module 331, which includes a water tank 333, water dispenser 334, water heater 335 and hot beverage dispenser 336. User interfaces 341 and 342 on the top and front of the housing, respectively, provide control buttons and a display that allow the user to control the functionality of the device 101 for food preparation, which can also be controlled through a wireless interface 314.

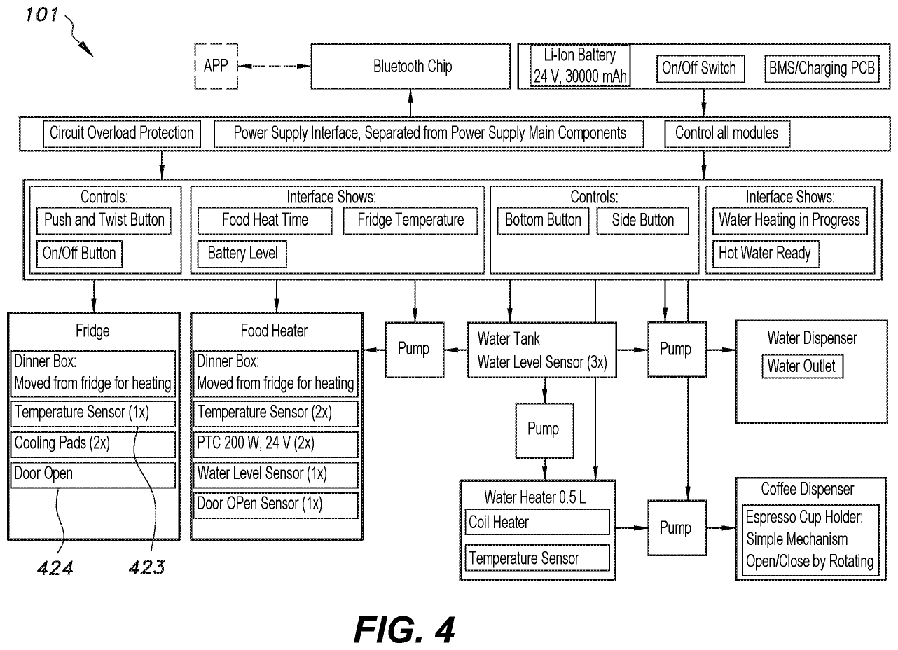

FIG. 4 is a schematic diagram showing additional details of the control system of FIG. 3. Features of the power supply module 311, central controller and power control module 312, wireless interface 314, and user interfaces 341 and 342 are depicted. The food refrigeration module 321 provides storage for prepared food items for heating or cooking or direct service (e.g., chilled items), as well as some food items for which most preparation is on-site. Also included in the food refrigeration module 321 are temperature sensor 423, door open sensor 424, and cooling elements, which can be provided as the aforementioned refrigeration or chill packages 225. The temperature sensor 423 provides data for cold monitoring, which can be effected by the central controller and power control module 312.

The food heating and cooking module 323 can be any suitable heating or cooking unit, and may be provided with thermal heating, radiant heating or microwave heating devices, as desired. If desired, steam heating or similar cooking arrangements can be included, which, for example, can include a rice cooker. As with any preparation, the food can be provided with a suitable container for the type of heating, or can be manually transferred into suitable containers.

A supply of water from the beverage module 331 may also be provided to facilitate food preparation involving adding water through a pump connected between the first water tank 333 and the food heating module 323. This facilitates the preparation of lyophilized food. The central controller and power control module 312 can be used to control water added during the preparation of food, which provides the correct mixture of water and also allows control of heating or cooking time.

The food heating and cooking module 323 can be provided with sensors to assure proper preparation of food, including, for example, temperature sensors, a moisture sensor and a water level sensor. The food preparation system may also include mounting points for supporting external cooking appliances, such as a portable range.

As mentioned, a beverage module 331 is provided, which includes a water tank 333, water dispenser 334, water heater 335, and hot beverage dispenser 336. The water tank 333 provides unheated water, and includes a water level sensor and temperature sensor in the water heater 335 to provide corresponding information to the central controller and power control module 312 and to provide a display of this information to the user. Water is dispensed as unheated water from the water dispenser 334, or as water heated by the water heater 335 using the hot beverage dispenser 336, which may be conveniently co-located with the water dispenser 334. Optionally, unheated water may be passed through the food refrigeration module 321, which can extract heat from the unheated water in order to dispense chilled water. The hot beverage dispenser 336 can be provided with appropriate coffee filter devices or espresso heads to dispense coffee or other hot beverages. This allows the hot beverage dispenser to selectively dispense hot water or prepare hot beverages.

It is to be understood that the portable food storage and preparation device is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

I claim:

1. A portable food storage and preparation device, comprising:
a housing having at least one axle and a pair of wheels mounted on the at least one axle to define a wheeled enclosure, the housing having a top and a front;
a portable power supply disposed in the housing;
a controller disposed in the housing, the controller being connected to the power supply;
a refrigeration compartment disposed in the housing, the refrigeration compartment including a cold storage area and a cooling source communicating with the cold storage area for maintaining temperatures in the refrigeration compartment below ambient temperature;
a food heating module disposed in the housing and including a food heating chamber and a heating device communicating with the food heating chamber for heating food within the food heating chamber;
a beverage module disposed in the housing and including a first water storage tank and a water heater having a second water tank, the water heater receiving water from the first water tank and heating the water in the second tank;
a beverage dispensing station disposed in the housing and connected to the first and second water tanks, selectively providing cold water from the first water storage tank and hot water from the second water tank; and
a hot beverage preparation device disposed in the housing and selectively receiving hot water from the second water tank for preparation of hot beverages, the controller providing power from the power supply to and controlling performance of the refrigeration module, food heating module, the beverage module, the beverage dispensing station, and the hot beverage preparation device.

2. The portable food storage and preparation device of claim 1, further comprising a wireless module connected to the controller, the wireless module permitting wireless control and monitoring of the portable food storage and preparation device.

3. The portable food storage and preparation device of claim 1, wherein the cooling source in said refrigeration compartment comprises a heat exchange refrigeration unit adapted for connection to a.c. power mains.

4. The portable food storage and preparation device of claim 1, wherein the cooling source in said refrigeration compartment comprises chill packs.

5. The portable food storage and preparation device of claim 1, further comprising a pump connected between the first water tank in said beverage module and said food heating module selectively adding water during food preparation.

6. The portable food storage and preparation device of claim 1, further comprising a storage drawer disposed in said housing for transport of food not requiring refrigeration and for transport of utensils.

7. The portable food storage and preparation device of claim 1, further comprising a retractable handle mounted on said housing for manually transporting said housing on the pair of wheels.

8. The portable food storage and preparation device of claim 1, further comprising user interfaces on the top and front of said housing having control buttons and displays for controlling operation of said food heating and beverage modules and said refrigeration compartment.

9. The portable food storage and preparation device of claim 8, further comprising temperature sensors in said refrigeration compartment and in said food heating and beverage modules, the temperature sensors being connected to said controller and said user interfaces for monitoring and control of the device.
